(19) United States
(12) Patent Application Publication
(10) Pub. No.: US 2025/0347007 A1
(43) Pub. Date: Nov. 13, 2025

(54) BUFFER SYSTEMS FOR PREVENTING CORROSION-RELATED DEGRADATION IN PEM WATER ELECTROLYSIS

(71) Applicant: Siemens Energy Global GmbH & Co. KG, München (DE)

(72) Inventors: Kim-Marie Vetter, Berlin (DE); Günter Schmid, Hemhofen (DE); Jamie Härtl, Erlangen (DE); Yashar Musayev, Nürnberg (DE); Thomas Reichbauer, Allershausen (DE)

(21) Appl. No.: 18/728,976

(22) PCT Filed: Nov. 2, 2022
(86) PCT No.: PCT/EP2022/080556

§ 371 Date: Dec. 31, 2024

(30) Foreign Application Priority Data
Jan. 21, 2022 (DE) 10 2022 200 687.9

(51) Int. Cl. C25B 9/23

(52) U.S. Cl. CPC C25B 9/23

(57) ABSTRACT

The invention relates to a membrane electrode arrangement including a cation exchange membrane arranged in a cell between an anode and a cathode, which has a respective catalyst layer on the anode side and cathode side, wherein the cell has a low molecular buffer with at least one alkali-metal cation. The cationic concentration of the buffer solution is <1 mmol. The invention also relates to a use of a low molecular buffer with at least one alkali-metal cation for water electrolysis, and a device comprising the membrane electrode arrangement.

The present invention relates to an assembly for PEM water electrolysis which comprises a low molecular weight buffer comprising at least one alkali metal cation.

In proton exchange membrane (PEM) electrolysis distilled water is conventionally split into hydrogen and oxygen by electrical current. A corresponding apparatus is also referred to as a PEM electrolyzer. PEM water electrolysis is a bearer of hope of renewable energies and a green energy supply. Already today, important technical parameters such as for instance long-term operation (>20 000 h), service life and stability of the systems (>10-20 years) as well as high current densities (2.0 A/cm²) have been met.

Document US 2016/024 669 A1 discloses an electrolysis cell comprising a cation exchange membrane which comprises a respective catalyst layer on the anode side and on the cathode side. Further documents in this field of industry are: Naito Takahiro et al., 2020, Chemsuschem 13, No. 22, pages 5921-5933, US 2009/294 282 A1 and WO 2018/103 769 A1.

The membrane employed is typically a proton-permeable membrane made of a polymeric material. A membrane electrode assembly consisting of a perfluorinated and sulfonic acid-functionalized cation exchanger (perfluorosulfonic acid, PFSA) membrane and two catalyst layers (for example iridium on the anode side and platinum on the cathode side) allows for dynamic and flexible operation of the electrolyzer. Corresponding systems already tolerate rapid startup and shutdown times from particular operating states and operating interruptions. In order to ensure this the MEA must be mechanically, chemically, thermally and oxidatively stable.

A central problem of PEM water electrolysis is contamination of the electrolyzer by foreign ions which enter the system through corrosion for example. Particularly relevant here are Fe³⁺, Al³⁺, Cr³⁺, Cu²⁺ and Ni²⁺.

On account of their strong interaction with the PFSA membrane the harmful effect on the MEA increases with increasing valence. Iron and aluminum ions are moreover particularly problematic since aluminum is known to attack the ether bridge in the PFSA side chain, thus leading to degradation, and iron can lead to fluoride elimination in a Fenton-like reaction. The liberation of metal cations from metal elements of construction is strongly pH-dependent. The lower the local pH value, the greater the corrosion.

This problem is conventionally mainly avoided by using ultrapure water (for example 18 MΩ·cm) and ideally corrosion-resistant materials in the cell/stack and process engineering setup. Nevertheless, contamination of the cell cannot be ruled out. It is an object of the present invention to prevent ions passing into the system and/or to remove or mask ions that have already passed into the system.

This object is achieved by a membrane electrode assembly having the features of claim 1. Further advantageous embodiments and configurations of the invention are apparent from the secondary claims and subsidiary claims, the figures and exemplary embodiments. The embodiments of the invention may advantageously be combined with one another.

A first aspect of the invention relates to a membrane electrode assembly comprising a cation exchange membrane which is arranged in a cell between an anode and a cathode and comprises a respective catalyst layer on the anode side and on the cathode side. The cell comprises a buffer solution comprising at least one alkali metal cation, wherein the buffer solution has a cationic concentration of <1 mmol.

The buffer solution is an aqueous buffer solution. The terms buffer solution and buffer are used synonymously here.

The advantage of the invention results from the electrochemical relationship. The corrosion of metal elements of construction is strongly dependent on the local pH value. On the anode side the oxygen evolution reaction (OER) forms protons:

$$2 {H}_{2} {O}_{( l )} \to {O}_{2 ( g )} + 4 {e}^{-} + 4 {H}_{( aq )}^{+} \qquad ( I )$$

This results in a low local pH value. The predominant portion of the protons are transported to the cathode via the membrane and reduced there to hydrogen (HER, hydrogen evolution reaction) but individual local variations in the ppm range cannot be avoided. This leads to a reaction with the metal elements of construction. To understand the consequences of this it is necessary to understand the pH dependence of the proceeding half-cell reactions (OER at the anode, HER at the cathode):

$$OER , pH 02 {H}_{2} {O}_{( l )} \to {O}_{2 ( g )} + 4 {e}^{-} + 4 {H}_{( aq )}^{+} + 1.23 V \qquad ( II )$$

$$OER , pH 14 \; 2 {OH}_{( eq )}^{-} \to {O}_{2 ( g )} + 4 {e}^{-} + 4 {H}_{2} {O}_{( l )} + 0.4 V \qquad ( III )$$

$$HER , pH 02 {H}_{( aq )}^{+} + 2 {e}^{-} \to {H}_{2 ( g )} + 4 {H}_{( eq )}^{+} 0 V \qquad ( IV )$$

$$HER , pH 14 \; 2 {H}_{2} {O}_{( l )} + 2 {e}^{-} \to {H}_{2 ( g )} + 2 {OH}_{( eq )}^{-} - 0.83 V \qquad ( V )$$

The pH value accordingly determines which reaction can preferentially proceed. This applies not only to OER and HER but also to the corrosion of metal elements which likewise represent an oxidation reaction. The following reaction equations result for the example of zinc and iron:

$$Fe \to 3 {e}^{-} + {Fe}_{( aq )}^{3 +} 0.04 V \qquad ( VI )$$

$$Zn \to 2 {e}^{-} + {Zn}_{( eq )}^{2 +} 0.76 V \qquad ( VII )$$

Whether corrosion proceeds or not may be illustrated with reference to the following equation (combination of two half-cell reactions) for the example of non-noble zinc:

$$2 n + 2 {H}_{( aq )}^{-} \to {H}_{2 ( g )} + {Zn}_{( aq )}^{2 +} \qquad ( VIII )$$

The potential of the reaction is calculated as the difference of the two electrode potentials. A reaction occurs as soon as ΔE>0:

$$For Zn , pH 0 Δ E = 0.76 - 0 = 0.76 \qquad ( IX )$$

$$For Fe , pH 0 Δ E = 0.04 - 0 = 0.04 \qquad ( X )$$

The pH-dependence of the reaction may be represented by the Nernst equation:

$$Δ E = {E}_{1} - {E}_{2} = {E}_{1}^{0} - {E}_{2}^{0} + \frac{RT}{{z}_{e} F} ln ( \frac{[ {Zn}^{2 +} ] * [ {H}_{2} ]}{[ Zn ] * [ {H}^{+} ]} ) \qquad ( XI )$$

The concentration of the zinc ions in the electrolyte [Zn²⁺] is negligibly small and the equation is accordingly only dependent on the proton concentration, i.e. the pH value. This leads to the simplified formula

$$Δ E = {E}_{1}^{0} - {E}_{2}^{0} - 0.059 V * pH \qquad ( XII )$$

For pH=0 the result corresponds to that above from equation (IX) or (X). As soon as the pH is increased the electrode potential for the corrosion reaction falls. For the example of a single pH unit (pH=1) the result changes as follows:

For Fe, pH 1:

$$Δ E = {E}_{1}^{0} - {E}_{2}^{0} - 0.059 V * 1 = 0.04 - 0 - 0.059 = - 0.019 \qquad ( XIII )$$

Accordingly, ΔE<0 and the reaction no longer takes place. The effect becomes ever stronger with increasing pH and corrosion is thus avoided ever more effectively.

Actively introducing alkali metal cation-based buffer systems makes it possible to avoid the occurrence of heavy losses through corrosion-mediated cationic contamination of the MEA. This is achieved through two effects brought about by the use of the buffer: Firstly the pH value in the bulk of the electrolyte is buffered. This makes it possible, particularly on the anode side, to buffer local pH changes resulting from protons from the oxygen evolution reaction (OER). For example in the case of a buffered pH value of 7 the effect described in (XIII) is utilized to completely avoid corrosion of, for example, iron in bipolar plates or gas diffusion layers.

Acid-mediated corrosion preferentially occurs at low pH values and competes with the OER. However, maintaining the pH value in the range from pH=2-8, preferably 4-8, using the bulk electrolyte buffer results in an overvoltage buffered by at least 413 mV relative to pH=0 which permits OER and inhibits corrosion. The same applies to corrosion resulting from the oxygen formed at the anode which is less aggressive at higher pH values than at low pH values. An acid-mediated oxidation of the bipolar plate (for electrical contacting) can thus advantageously be avoided.

Secondly, the anion of the buffer can scavenge corrosive metal ions through precipitation. This makes it possible to render harmless any corrosion that occurs despite the buffering effect and any associated liberation of metal ions, for example Fe³⁺ ions, into the electrolyte circuit by scavenging the metal ion through precipitation of a precipitate in the solution. The precipitate may then be advantageously removed from the electrolyte circuit by filtration.

In other words the assembly according to the invention is advantageous because introduction of monovalent cations in the context of a phosphate-based buffer system makes it possible to precipitate, and thus remove from the system, harmful metal ions as insoluble phosphate, for example FePO₄. Heavy contamination with a polyvalent metal ion is avoided since said ion is effectively replaced by an alkali metal ion.

The buffer solution has a cationic concentration of <1 mmol. A higher concentration ≥1 mmol brings about a significant potential drop which impairs the efficiency of the system.

It is preferable when the buffer solution comprises at least one anion that forms poorly soluble salts with polyvalent metal cations. This advantageously permits removal of unwanted metal ions from the assembly through formation of poorly soluble salts. The buffer solution comprises at least one anion selected from the group comprising phosphate, hydrogenphosphate, dihydrogenphosphate, hydrogencitrate and silicate.

The buffer solution comprises at least two or more phosphate derivatives as the anion. Phosphate forms poorly soluble salts with for example the corrosion-relevant metal ions Fe³⁺ (solubility product (FePO₄)=1.3×10⁻²²), Ni²⁺ (solubility product (Ni₃(PO₄)₂)=4.74×10⁻³²) and Cr³⁺ (solubility product (CrPO₄)=6.7×10⁻³¹).

It is further preferable when the cation of the buffer solution is selected from the group comprising lithium, sodium and potassium. Through introduction of monovalent cations in the context of a phosphate-based buffer system for example harmful Fe³⁺ can be precipitated as insoluble iron phosphate (FePO₄) and thus specifically removed from the system. This advantageously avoids heavy contamination with a corrosive metal ion (for example Fe³⁺) since said ion is effectively replaced by an alkali metal ion (for example Li⁺).

That being said, not every cationic additive is suitable for passing through the membrane. The membrane is permeable particularly for the monovalent alkali metal ions, especially the aforementioned Li⁺, Na⁺, and K⁺, due to the overvoltage caused by the transport of the cations but has only low permeability, if any at all, for higher-valent metal ions.

The pH value of the buffer solution is preferably in the range of 2-8. The pH value of the buffer solution is particularly preferably in the range of 4-8. Acid-mediated corrosion occurs preferentially at low pH values and competes with the OER. However, maintaining the pH value in the range of pH=2-8, preferably 4-8, using the buffer results in an overvoltage buffered by at least 413 mV relative to pH=0 which permits OER and inhibits corrosion. The same applies to corrosion resulting from the oxygen formed at the anode which is less aggressive at higher pH values than at low pH values. An acid-mediated oxidation especially of the bipolar plate (for electrical contacting) can thus be avoided.

A second aspect of the invention relates to a use of a low molecular weight buffer comprising an alkali metal cation having a cationic concentration of <1 mmol in a PEM membrane electrode assembly.

A third aspect of the invention relates to an apparatus comprising an assembly according to the invention. Apparatuses are for example electrolyzers and fuel cells.

In a particularly advantageous configuration and application an electrolyzer is thus provided with such a membrane electrode assembly, wherein in operation of the electrolyzer water is supplied as the reactant and electrochemically split into oxygen and hydrogen as the products, wherein in the cell of the membrane electrode assembly a buffer solution comprising at least one alkali metal cation is provided, wherein the buffer solution has a cationic concentration of <1 mmol. The desired cationic concentration of <1 mmol is preferably established and then monitored in operation of the electrolyzer. The buffer solution may circulate in a circuit in operation of the electrolyzer and if required the cationic concentration may be maintained in a range smaller than the desired maximum value, for instance be adjusted by addition of fresh buffer solution from a reservoir and/or discharging of buffer solution. This allows continuous electrolysis operation, thus reducing or avoiding degradation of the PEM electrolysis cell in situ.

The advantages of the use and the apparatus correspond to the advantages of the assembly according to the invention.

The invention will now be more particularly elucidated with reference to the figures. In the figures:

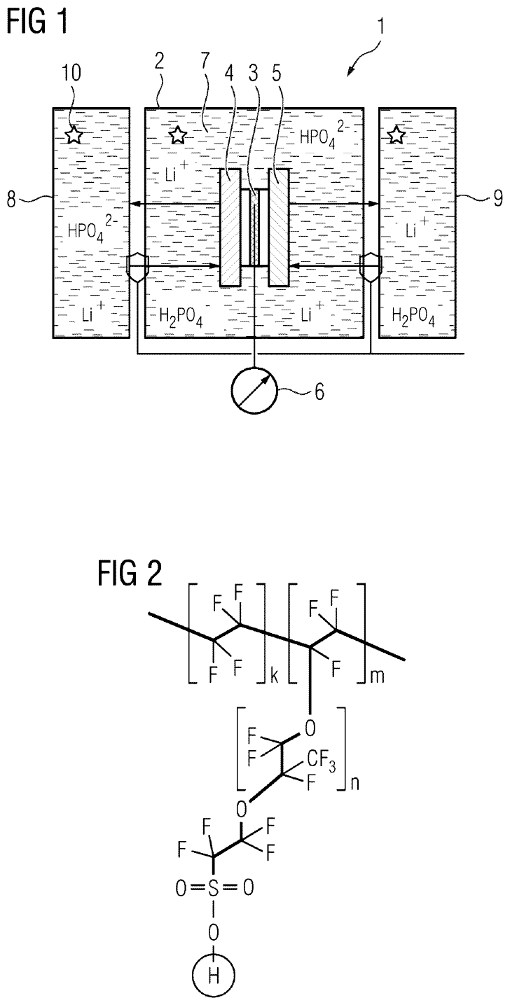

FIG. 1 shows an embodiment of a PEM electrolysis cell;

FIG. 2 shows a representation of the molecular structure of perfluorosulfonic acid;

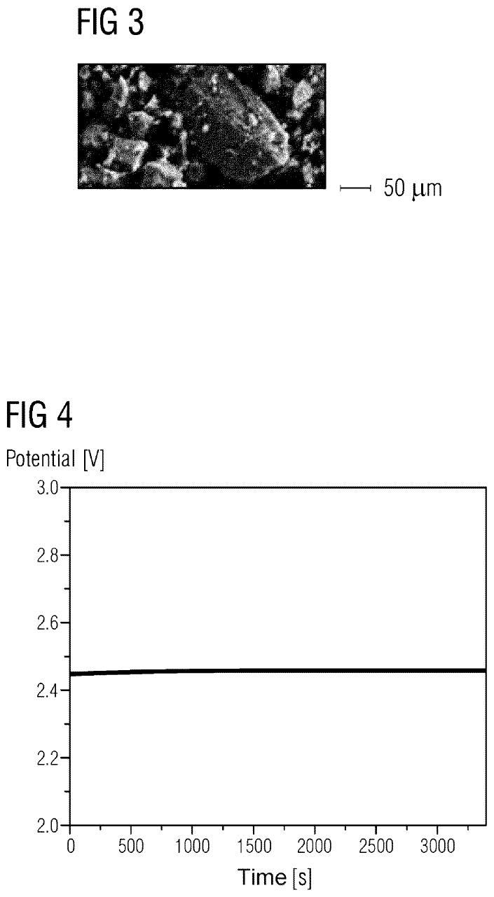

FIG. 3 shows an electron micrograph: of iron phosphate crystals;

FIG. 4 shows a diagram for representing voltage losses at a molar concentration of lithium ions of 1 μM;

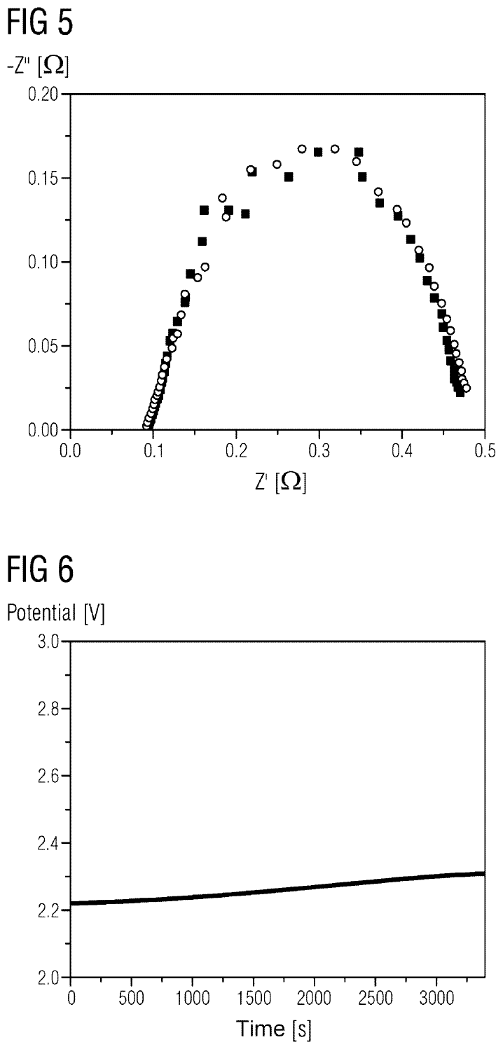

FIG. 5 shows a Nyquist plot for representing the resistance in the system at a concentration according to FIG. 4;

FIG. 6 shows a diagram for representing voltage losses at a molar concentration of lithium ions of 10 μM;

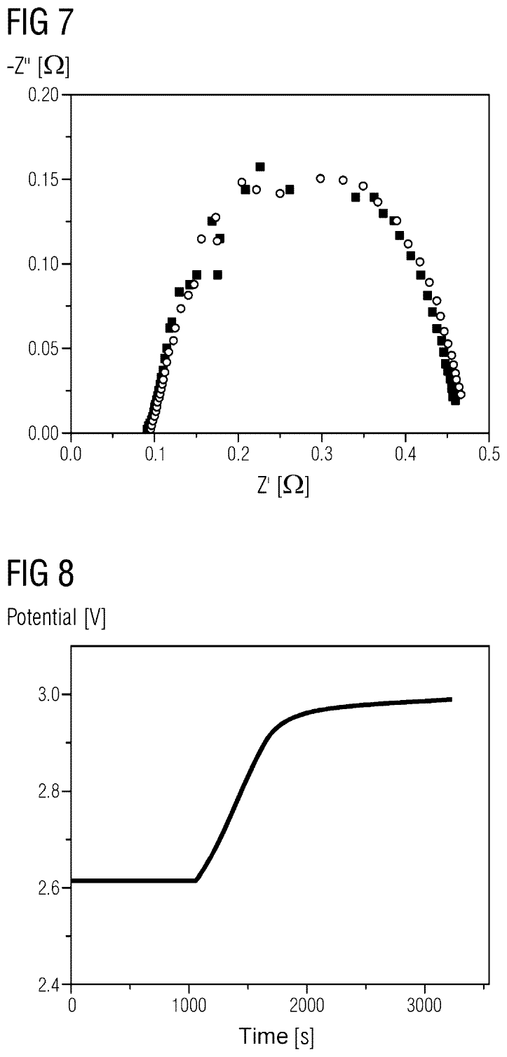

FIG. 7 shows a Nyquist plot for representing the resistance in the system at a concentration according to FIG. 6;

FIG. 8 shows a diagram for representing voltage losses at a molar concentration of potassium ions of 1 mM;

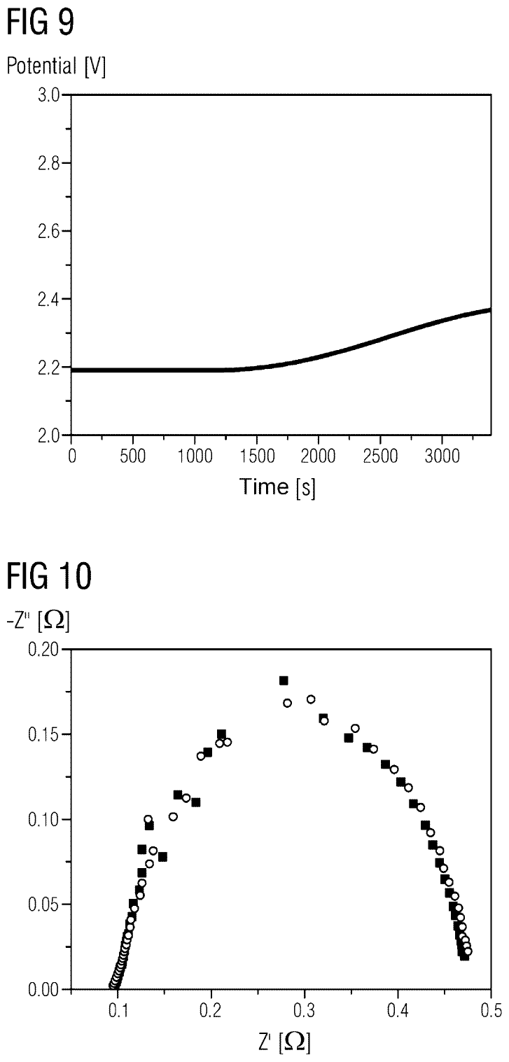

FIG. 9 shows a diagram for representing voltage losses at a molar concentration of potassium ions of 100 μM;

FIG. 10 shows a Nyquist plot for representing the resistance in the system at a concentration according to FIG. 9;

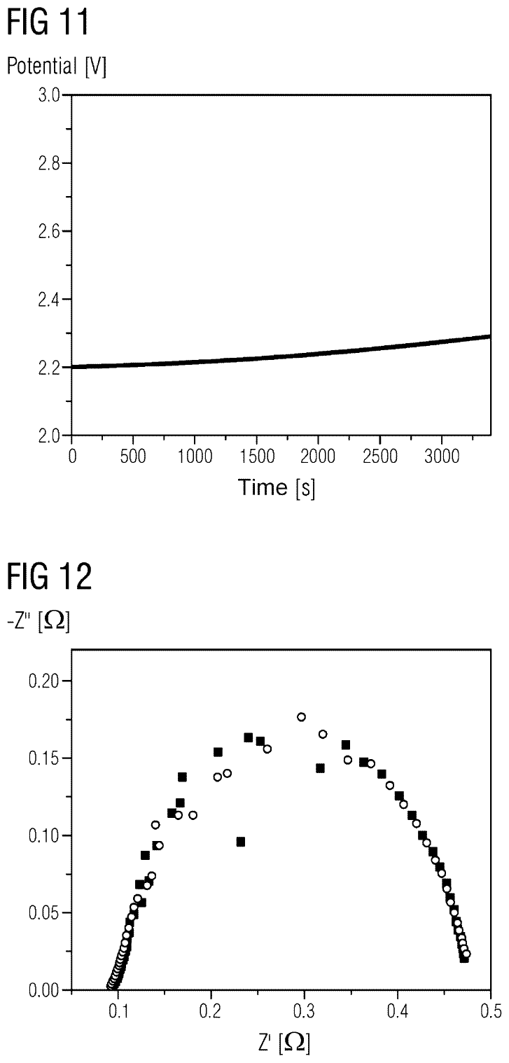

FIG. 11 shows a diagram for representing voltage losses according to the molar concentration of potassium ions of 10 μM;

FIG. 12 shows a Nyquist plot for representing the resistance in the system at a concentration according to FIG. 11.

An assembly 1 comprising a PEM electrolysis cell 2 according to the embodiment shown in FIG. 1 comprises a perfluorinated and sulfonic acid-functionalized (PFSA) membrane 3. The molecular structure of PESA is shown in FIG. 2.

The membrane 3 is a proton-permeable polymer membrane. The membrane 3 is coated with a platinum-comprising electrode 4 on the cathode side and with an iridium-comprising electrode 5 on the anode side. The electrodes 4, 5 are connected by a voltage source 6 to allow an external voltage to be applied thereto.

Respective gas diffusion layers abut the electrodes and are each contacted by a so-called bipolar plate. The setup and arrangement of these features belong to the general knowledge of a person skilled in the art.

The PEM electrolysis cell 2 is flooded with a low molecular weight buffer solution 7. The buffer solution comprises lithium ions Li⁺ and hydrogenphosphate HPO₄²⁻ and dihydrogenphosphate ions H₂PO₄⁻. The PEM electrolysis cell 2 is connected with a cathode-side electrolyte circuit 8 on the cathode side and with an anode-side electrolyte circuit 9 on the anode side. Instead of lithium ions it is also possible to employ other monovalent alkali metal ions, for example Na⁺ or K⁺. Employable counterions other than hydrogenphosphate HPO₄²⁻ and dihydrogenphosphate ions H₂PO₄⁻ also include with particular preference phosphate ions PO₄⁻ but also hydrogencitrate, silicate and mixtures of the aforementioned ions.

Due to the poor solubility of for example iron phosphate the anion of the buffer (for example HPO₄²⁻) scavenges the Fe³⁺ through precipitation. A corresponding precipitate 10 is non-harmful, since it is externally neutral, and can be removed by filtration. The precipitation of iron phosphate is elucidated via the stars (precipitate 10) in FIG. 1. The precipitation proceeds according to the following reactions:

$${HPO}_{4}^{2 -} + {Fe}^{3 +} \to {H}^{+} + {FePO}_{4} and$$

$${H}_{2} {PO}_{4}^{2 -} + {Fe}^{3 +} \to 2 {H}^{+} + {FePO}_{4} .$$

Precipitated iron phosphate is shown as an electron micrograph in FIG. 3. In addition to Fe³⁺ (solubility product (FePO₄)=1.3×10⁻²²), further cations relevant to corrosion such as for example nickel Ni²⁺ (solubility product (Ni₃(PO₄)₂)=4.74×10⁻³²) and chromium Cr³⁺ (solubility product (CrPO₄)=6.7×10⁻³¹) are precipitated.

The relevant concentration range for the introduced buffers is <1 mmol. In the context of an electrochemical study it was shown that the use of a buffer system in the case of Lit as the cation has no adverse effects on the system under consideration up to about 10 μM (FIGS. 4 and 6). The potential was measured over time.

At a concentration of 1 μM of an Lit-based buffer the system remains completely constant, i.e. no potential increase from the time of addition of the buffer (indicated by the arrow) occurs (FIG. 4). Even at a concentration of 10 μM no appreciable potential increase is observed (FIG. 6).

This was established in a galvanostatic experiment (running time 1 h, current density 1.0 A/cm²) by addition of the corresponding buffer (after 15 min) where no potential loss was recorded. This information was verified by electrochemical impedance spectroscopy which showed that no significant increase in membrane resistance occurred at 1 μM or at 10 μM Li⁺ phosphate buffer.

FIGS. 5 and 7 show Nyquist plots corresponding to the experiments of FIGS. 4 and 6. In the Nyquist plots resistance is measured by applying an alternating voltage via a low current density (10 mA/cm²) at different frequencies to measure the resistance (resolved into its imaginary proportions on the x-axis and the y-axis). In simple terms membrane resistance may be read off at the origin of the discernible semicircle on the left-hand side and so-called charge transfer resistance may be read off at the semicircle width (i.e. practically the zero crossing on the right-hand side minus the zero crossing on the left-hand side). The shaded circles correspond to the values for water while the unshaded circles correspond to the values with the added ions. It is apparent that at the low concentrations the measurements with buffer do not differ from those with pure water within the limits of measurement accuracy. By contrast, there is a discernible voltage increase (FIGS. 10 and 12) at higher concentration.

In an analogous investigation with K⁺ ions (as chloride) it was observed that at a concentration of 1 mM K⁺ a significant voltage drop occurs which impairs the efficiency of the system (FIG. 8). At 100 μM K⁺ (as chloride) a marked potential increase from the time of addition is still observable but this is already substantially lower than at 1 mM (FIG. 9). The resistance of the system hardly changes (FIG. 10). At 10 μM K⁺ the observed potential increase is even more markedly reduced and hardly visible anymore (FIG. 11), wherein here too the resistance in the system hardly changes (FIG. 12).

Modifications and alterations of the invention that are obvious to a person skilled in the art fall within the scope of protection of the claims.

1. An electrolysis cell (2) comprising a membrane electrode assembly (1), comprising a cation exchange membrane (3) which is arranged between an anode and a cathode and comprises a respective catalyst layer on the anode side and on the cathode side, characterized in that a buffer solution (7) comprising at least one alkali metal cation and at least one anion selected from the group comprising phosphate, hydrogenphosphate, dihydrogenphosphate, hydrogencitrate and silicate and comprising at least one phosphate is provided, the pH value of the buffer solution (7) is in the range of 2-8 and wherein the buffer solution (7) has a cationic concentration of <1 mM and at least 1 μM.

2. The electrolysis cell (2) as claimed in claim 1, wherein the buffer solution (7) comprises at least one anion that forms poorly soluble salts with polyvalent metal cations.

3. The electrolysis cell (2) as claimed in either of the preceding claims, wherein the cation of the buffer solution (7) is selected from the group comprising lithium, sodium and potassium.

4. The electrolysis cell (2) assembly as claimed in claim 1, wherein the pH value of the buffer solution (7) is in the range of 4-8.

5. The use of a low molecular weight phosphate-based buffer solution comprising an alkali metal cation having a cationic concentration of <1 mM and at least 1 μM in a PEM electrolysis cell (2).
